(19) United States
(12) Patent Application Publication
(10) Pub. No.: US 2006/0023113 A1
(43) Pub. Date: Feb. 2, 2006

(54) Ball type camera able of changing lens module

(75) Inventor: Frank Lin, Taipei County (TW)

Correspondence Address: BRUCE H. TROXELL;SUITE 1404, 5205 LEESBURG PIKE, FALLS CHURCH, VA, 22041, US

(73) Assignee: AcutVista Innovation co., Ltd.

(21) Appl. No.: 10/900,144

(22) Filed: Jul. 28, 2004

(51) Int. Cl. H04N 5/225

(52) U.S. Cl. 348/373

(57) ABSTRACT

The ball type camera able of changing a lens module comprises: a swivel table mechanism for rotating in a horizontal plane for 360 degrees without segmentation and a rocking mechanism for rotating up and down for 90 degrees without segmentation. Wherein the rocking mechanism has a rotation seat driven by the swivel table mechanism for rotating for 360 degrees and a rocking member; the rotation seat is mounted thereon with a motor and a driving gear, the rocking member mounted with the lens module is pivotally connected to the rotation seat, the rocking member has thereon a sheet gear engaging with the driving gear; the motor on the rotation seat runs to move the sheet gear through transmitting of the driving gear to make the rocking member move the lens module on the vertical plane for rotating up and down for 90 degrees without segmentation; With this combination, the lens module can be removed from the rocking member for changing.

### BACKGROUND OF THE INVENTION

1. Field of the Invention

The present invention is related to a novel structure of a ball type camera, and especially to a ball type camera able of changing a lens module.

2. Description of the Prior Art

Concerning the structure of a Pan/Tilt camera, it uses two motors for operation, thereby the optic lens of the camera can displace in an up and down direction as well as a left and right direction, in order to trace an object for taking its images. A controller used for correcting the lens direction, it allows a user to see on the screen of a display a subject taken by the camera by a method of scanning and detecting, and the subject can be adjusted to be located at the center of the screen of the display. Such a method of scanning and detecting primarily controls operation of the two motors to render the optic lens of the camera to displace in an up and down direction as well as a left and right direction, in order to trace the object for taking its images.

However, by fast advancing of the manufacturing technique for CCD modules, optic lenses of cameras have many different specifications, such as Fix Lens Modules, Zoom lens CCD Modules, night vision CCD Modules, Modules added with IR LEDs . . . etc.

These CCD Modules have their respective scopes of using, and are suitable for mounting in the sites of different external conditions. Motors of a CCD Module are mounted in a housing of a camera mechanism. If a CCD Module is to be changed for a different one, the entire camera mechanism must be changed, this increases the cost of production and the pressure of stocks stored.

### SUMMARY OF THE INVENTION

Therefore, the present invention makes improvement against the defects of the prior art; it mainly has the rear area of a rotation seat enlarged to have a large sheet member mounted thereon with a motor and a driving gear set, and a rocking member is connected with a housing mounted with a lens module; the rocking member is pivotally connected to the rotation seat, and is connected with a sheet gear engaging with a driving gear. Thereby, running of the motor can be transmitted to the sheet gear through the driving gear to make the rocking member move the lens module on a vertical plane orthogonal to a horizontal plane to rotate up and down for 90 degrees without segmentation. By virtue that motors are mounted on the rotation seat rather than in the housing of the mechanism of the camera, when it is desired to change for a different lens module in pursuance of a different field of application, assembling of the different lens module can be completed just by mounting the different lens module on the rocking member. Such a designing can be convenient for production, can reduce stocks and lower the cost of management; and also can render a customer to flexibly use it in different fields by mounting different lens modules.

And more, the Pan/Tilt supporting structure of the present invention can be rotated rightwards and leftwards for 360 degrees without segmentation and can be rotated up/down for 90 degrees without segmentation, the camera can be positioned and controlled by a program, the positioning spots can be set to be 60 spots, and can be increased.

The Tilt axle positioning of the present invention is achieved by using a variable resistance and a motor in an open mode, it is easy for repairing and changing, and the space of operation for a CCD Module is increased.

The control signal lines of the Tilt axle of the present invention adopt soft buses; they have long life and are small in volume, and are easy for repairing and changing.

The control signal lines of the Pan axle of the present invention adopt soft buses of volute types; they can be rotated for over 360 degrees, they have long life and are structurally simple, and take a printed circuit board (PCB) as their axis of rotation.

The present invention will be apparent in its structural features and effects of operation after reading the detailed description of the preferred embodiment thereof in reference to the accompanying drawings.

### BRIEF DESCRIPTION OF THE DRAWINGS

FIG. 1 is a perspective view showing the appearance of the present invention;

FIG. 2 is a complete analytic perspective view of the present invention;

FIG. 3 is an enlarged analytic perspective view of a rocking member of the present invention;

FIG. 4 is an analytic perspective view showing the components partially assembled and partially detached of the rocking member of the present invention;

FIG. 5 is a schematic view partially in sectional views of the present invention;

FIG. 6 is an exploded perspective view of a part of a swivel table mechanism of the present invention. and

FIG. 7 is a perspective bottom view of the present invention of which a bottom cover has been removed.

### DETAILED DESCRIPTION OF THE PREFERRED EMBODIMENT

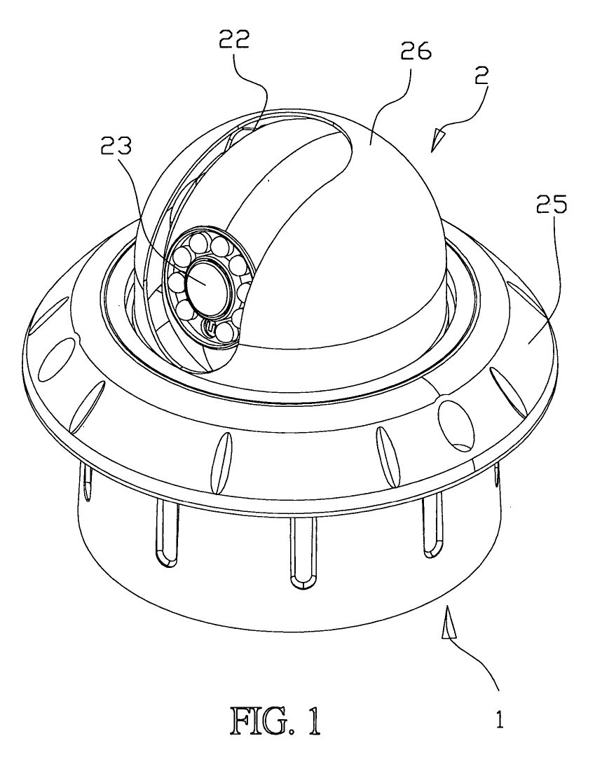

Referring to FIG. 1, the ball type camera able of changing a lens module of the present invention mainly comprises two parts; one is a lower swivel table mechanism 1, the other is a rocking mechanism 2 above the swivel table mechanism 1. Wherein the swivel table mechanism 1 is provided therein with a power transmitting mechanism 104 driven by a first motor, thus a transmitting member 106 can be rotated in a horizontal plane for 360 degrees without segmentation, namely, this is a mechanism able to render rotary of a Pan axle. The rocking mechanism 2 is mounted with a lens module 23 of the camera, and allows the lens module 23 to rotate up and down for 90 degrees without segmentation; namely, this is a mechanism rendering a Tilt axle to rotate. The present invention does programmable positioning and controlling on the lens module 23 for rotating rightwards and leftwards for 360 degrees without segmentation and for rotating up and down for 90 degrees without segmentation, its positioning spots can be set to be 60 spots, and can be increased.

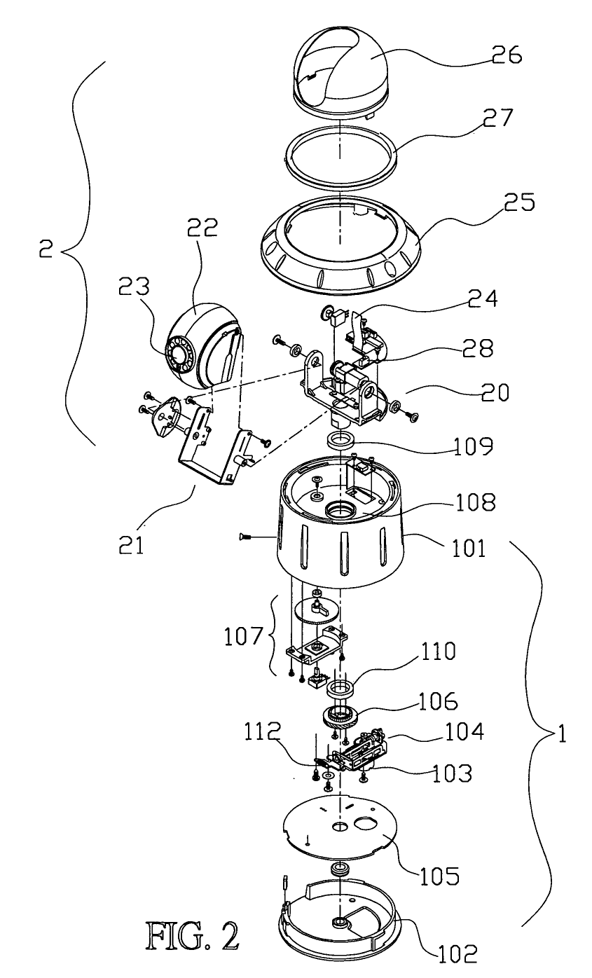

Referring to the analytic perspective view of FIG. 2, the structure of the swivel table mechanism 1 includes a cylindrical base 101 of which a bottom cover 102 on a bottom end is sealed; and the structure has therein a power transmitting mechanism 104 driven by a first motor 103, and a control electric circuit board 105. A transmitting member 106 is rotated by the first motor 103 to drive the power transmitting mechanism 104, so that the transmitting member 106 can be rotated in a horizontal plane for 360 degrees without segmentation. A potentiometer 107 controls the rotation angle of the transmitting member 106.

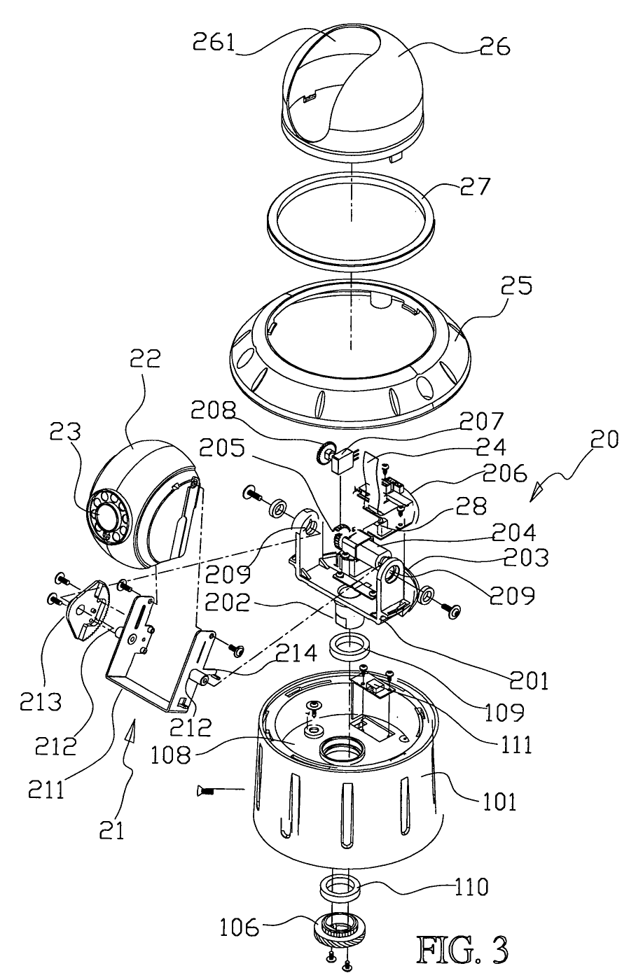

And referring to FIGS. 2 and 3, the upper rocking mechanism 2 mainly is provided with a rotation seat 20 basically including a U shaped rack 201, a rotation axle 202 extends down centrally therefrom; the rotation axle 202 is tightly fitted in the transmitting member 106 of the swivel table mechanism 1; thereby when the transmitting member 106 is driven to rotate, it makes the rotation seat 20 to rotate simultaneously; the connecting area of the rotation axle 202 with the transmitting member 106 has an upper bearing 109 and a lower bearing 110 to make firm and smooth rotation of the rotation axle 202.

The rotation seat 20 has a sheet member 203 extending on the rear thereof, and is provided thereon fixedly with a second motor 204, a driving gear 205 and a control circuit board 206. A variable resistance 207 has thereon a gear 208 engaged with the driving gear 205 to detect the rotation angle of the latter, and thereby running of the second motor 204 can have programmable control.

A rocking member 21 including a U shaped rack 211 has a pair of pivot axles 212 extending outwardly and laterally therefrom, the pivot axles 212 are respectively pivotally connected to two round holes 209 provided on two lateral sides of a U shaped rack 201 of the rotation seat 20 and are positioned with screws and gaskets, so that the rocking member 21 takes the central line of the pivot axles 212 as a center for up and down rotation without segmentation. One lateral sidewall of the U shaped rack 211 of the rocking member 21 is mounted with a sector shaped gear sheet 213, the teeth of the gear sheet 213 are engaged with the driving gear 205 of the rotation seat 20; that is to say, running of the second motor 204 can control and move the rocking member 21 through the driving gear 205 to rotate up and down taking the pivot axles 212 as its center.

The opening of the U shaped rack 211 of the rocking member 21 is fixedly connected therein with a housing 22 by using bolts, the housing 22 is mounted therein with the lens module 23. The housing 22 is a structural member opened at a vertical seam in its middle to allow taking out and placing in of the lens module 23.

The control circuit board 206 of the rotation seat 20 has a soft bus 24 (shown by broken lines in the drawing) extending thereon and extending to the optic lens module 23 in the housing 22 for transmitting of signals.

The base 101 is mounted on its top edge with a fixing disk 25 and a camera hood 26 in the form of a ball, a sealing ring 27 is provided at the connecting area of the two members. The top end of the ball shaped camera hood 26 is provided with an elongate opening 261 extending downwards to allow the lens module 23 to rotate up and down for 90 degrees in the opening 261 as is shown in FIG. 1.

The partition plate 108 of the base 101 is mounted with a control switch 111 to be contacted by a protrusion beneath the rocking member 21 (not shown) to stop the first motor 103 or to make it turn conversely.

In the same way, the control circuit board 206 also is mounted with a control switch 28 to be contacted by a protrusion 214 on the rear side of the rocking member 21 to stop the second motor 204 or to make it turn conversely.

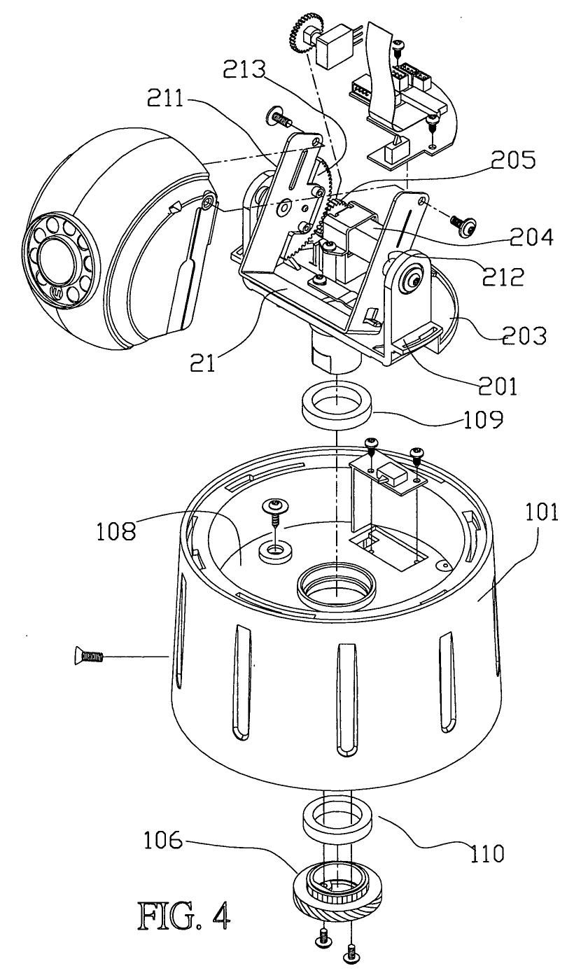

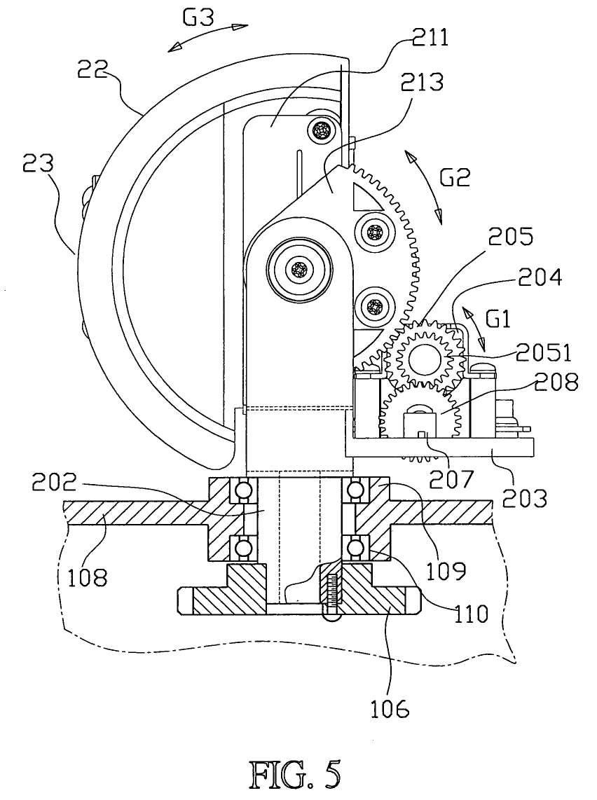

In order to clearly describe the up and down rotation of the rocking mechanism 2, please refer to FIGS. 4 and 5; the rotation axle 202 beneath the rotation seat 20 is assembled with the transmitting member 106 of the base 101 as well as the upper bearing 109 and the lower bearing 110, so that the optic lens module 23 on the rotation seat 20 can be rotated rightwards and leftwards in a horizontal plane without segmentation by rotation of the transmitting member 106. Meantime, the sector shaped gear sheet 213 of the rocking member 21 pivotally connected with the rotation seat 20 is engaged with the driving gear 205 rotated by the second motor 204, hence when the second motor 204 runs to drive the driving gear 205 in a direction shown with an arrow G1 as in FIG. 5, the sector shaped gear sheet 213 will rotate in a direction shown with an arrow G2, and the lens module 23 fixedly mounted on the rocking member 21 will rotate in a direction shown with an arrow G3, thereby the rotation of up and down for 90 degrees without segmentation can be effected.

In FIG. 5, the gear 208 of the variable resistance 207 is engaged with a small gear 2051 coaxially connected with the driving gear 205, but not directly engaged with the driving gear 205.

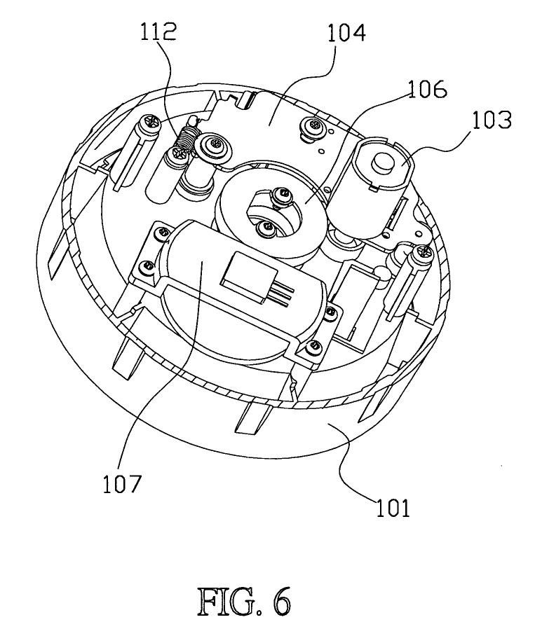

FIG. 6 shows the structure of the swivel table mechanism 1. Wherein the first motor 103 makes moving of the power transmitting mechanism 104, and in turn the transmitting member 106 in the form of a gear rotates, the potentiometer 107 controls and detects the rightward and leftward rotation of the first motor 103 in a horizontal plane. Certainly, the power transmitting mechanism 104 is connected with a stretchable spring 112, like a clutch; once the transmitting member 106 is unable to transmit power, the power transmitting mechanism 104 elastically jumps away automatically to avoid damage of the transmitting member 106 and the potentiometer 107.

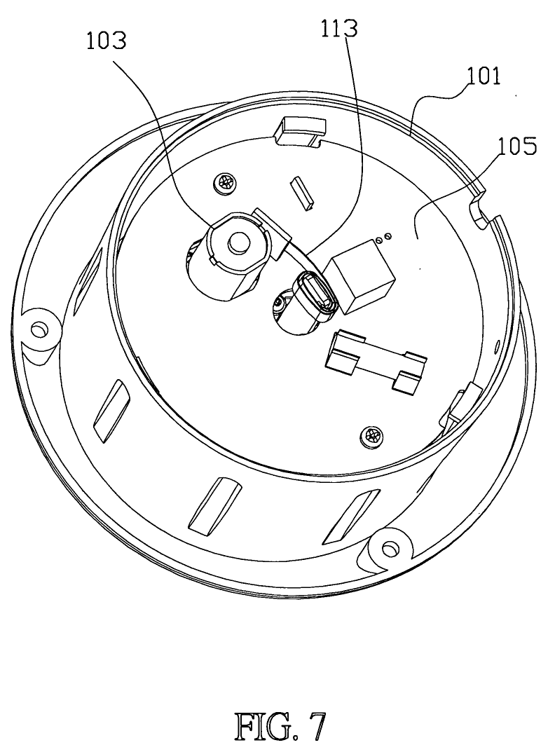

Referring to FIG. 7, the control electric circuit board 105 on the bottom of the swivel table mechanism 1 is mounted with a soft bus 113 of volute type as control signal lines connecting with the potentiometer 107; it takes the printed circuit board 105 as an axis of rotation, so that the swivel table mechanism 1 (Pan axle) can be rotated for over 360 degrees, the entire mechanism 1 thus has a long life and is made structurally simple.

With the above stated brand-new structure, it has been described that the housing 22 is only mounted with the lens module 23 and does not have the motors and the power transmitting mechanism 104 together provided in the housing 22. Such an opened designing will make changing of the lens module 23 very easy; an operator just needs to remove (after loosening the locking screws) the housing 22 from the rocking member 21, he can change for a CCD Module of a different specification, and can have the soft bus 24 connected to the new loaded lens module; then the housing 22 can be remounted on the rocking member 21.

With such a designing, not only that it is convenient for a customer to flexibly mount a different lens module in a different field, but also manufacturers can conveniently produce all lens modules of various specifications with the same Pan/Tilt supporting structure, thus an important effect that cost of management is lowered can be obtained.

Having thus described the ball type camera able of changing a lens module of the invention, what I claim as new and desire to be secured by Letters Patent of the United States are:

1. A ball type camera adapted for changing a lens module comprising:
a swivel table mechanism provided therein at least with a power transmitting mechanism driven by a first motor, in order that a transmitting member is adapted for rotating in a horizontal plane for 360 degrees without segmentation;
a rocking mechanism provided with a rotation seat which is mounted thereabove with a lens module of said camera, and is provided therebeneath with a rotation axle to connect with said transmitting member of said swivel table mechanism for rotating in said horizontal plane;
said ball type camera is characterized by that:
said rotation seat of said rocking mechanism is provided thereon fixedly with a second motor and a driving gear; a rocking member mounted with said lens module is pivotally connected to said rotation seat, said rocking member is provided thereon with a sheet gear engaging with said driving gear; said second motor runs to move said sheet gear through transmitting of said driving gear, to thereby make said rocking member move said lens module on a vertical plane orthogonal to said horizontal plane to rotate up and down for 90 degrees without segmentation; said lens module is adapted to removing from said rocking member for changing.

2. A ball type camera adapted for changing a lens module as claimed in claim 1, wherein,
said lens module is adapted for rotating rightwards and leftwards for 360 degrees without segmentation and is adapted for rotating up/down for 90 degrees without segmentation, positioning spots for said lens module are set to be 60 spots, and are adapted to increasing.

3. A ball type camera adapted for changing a lens module as claimed in claim 1, wherein,
said rotation seat of said rocking mechanism is a U shaped rack, said rotation axle extends down centrally therefrom; said rotation axle is tightly fitted in said transmitting member of said swivel table mechanism; thereby when said transmitting member is driven to rotate, it makes said rotation seat to rotate simultaneously;

4. A ball type camera adapted for changing a lens module as claimed in claim 3, wherein,
a connecting area of said rotation axle with said transmitting member of said swivel table mechanism has an upper bearing and a lower bearing to make firm and smooth rotation of said rotation axle.

5. A ball type camera adapted for changing a lens module as claimed in claim 3, wherein,
said rotation seat has a sheet member extending on the rear thereof, and is provided thereon fixedly with a control circuit board except said second motor and said driving gear.

6. A ball type camera adapted for changing a lens module as claimed in claim 1, wherein,
said driving gear is adapted for engaging with a gear of a variable resistance to detect a rotation angle of said driving gear, and thereby running of said second motor has programmable control.

7. A ball type camera adapted for changing a lens module as claimed in claim 3, wherein,
said rocking member is a U shaped member and has a pair of pivot axles extending outwardly and laterally therefrom, said pivot axles are respectively pivotally connected to two round holes provided on two lateral sides of said U shaped rack of said rotation seat, so that said rocking member takes a central line of said pivot axles as a center for up and down rotation without segmentation.

8. A ball type camera adapted for changing a lens module as claimed in claim 7, wherein,
said U shaped rack of said rocking member is mounted with said gear sheet, teeth of said gear sheet are engaged with said driving gear of said rotation seat; running of said second motor controls and moves said rocking member through said driving gear to rotate up and down taking said pivot axles as its center.

9. A ball type camera adapted for changing a lens module as claimed in claim 8, wherein,
said gear sheet has a sector shape, and is mounted on one lateral sidewall of said U shaped rack by using screws.

10. A ball type camera adapted for changing a lens module as claimed in claim 7, wherein,
an opening of said U shaped rack is fixedly connected therein with a housing, said housing is mounted therein with said lens module.

11. A ball type camera adapted for changing a lens module as claimed in claim 10, wherein,
said housing is a structural member opened a vertical seam in its middle to allow taking out and placing in of said lens module.

12. A ball type camera adapted for changing a lens module as claimed in claim 5, wherein,
said control circuit board has a soft bus extending thereon and extending to said lens module for transmitting of signals.

13. A ball type camera adapted for changing a lens module as claimed in claim 5, wherein,
said control circuit board is mounted with a control switch to be contacted by a protrusion on the rear side of said rocking member to stop said second motor or to make it turn conversely.

14. A ball type camera adapted for changing a lens module as claimed in claim 1, wherein,
a printed circuit board is provided on the bottom of said swivel table mechanism and is mounted with a soft bus of a volute type as control signal lines connecting with a potentiometer provided on one side of said swivel table mechanism; it takes said printed circuit board as an axis of rotation.
